(19) United States
(12) Patent Application Publication
(10) Pub. No.: US 2006/0049290 A1
(43) Pub. Date: Mar. 9, 2006

(54) Food grater

(76) Inventor: Pawel Kuzan, Oakville (CA)

Correspondence Address: Mirek A. Waraksa, Suite 1707, 145 Marlee Avenue, Toronto, ON, M6B 3H3, CA

(21) Appl. No.: 10/935,106

(22) Filed: Sep. 8, 2004

(51) Int. Cl. B02C 17/02

(52) U.S. Cl. 241/95

(57) ABSTRACT

A food grater is adapted to reduce formation of ribs and striations in foodstuffs during grating. A grating element includes a rigid base that defines an operative surface from which projections are raised, each projection having an aperture and a cutting edge surrounding the aperture. The projections are distributed as in a pseudorandom pattern such that any straight path extending along the operative surface in any direction through the projections is obstructed by at least one cutting edge.

### FIELD OF THE INVENTION

The invention relates generally to food graters, and more specifically, to preventing formation of pronounced striations and ribs in a foodstuff that can impair grating action.

### DESCRIPTION OF THE PRIOR ART

The invention has particular though not exclusive application to cheese graters. It is a common practice to grate a hard cheese, such as parmesan, on a steel grater that has a planar surface from which domed projections are stamped. Each projection is stamped with a central aperture to define the cutting edges required for grating. The projections are normally arranged in rows with common spacing between adjacent projections. Alternate rows are staggered relative to immediately adjacent rows by one-half of the spacing between adjacent projections. As a result, the projections form staggered columns spaced from one another by one-half of the common spacing between projections in each row.

With the grater oriented vertical, a user simply scrapes a foodstuff in an up-and-down motion against the projections. A hard foodstuff, such as parmesan cheese, tends to develop ribs and striations that conform to the vertical grooves between columns of projections. The ribs tend to space the body of the foodstuff from the projections which can severely impair grating action. This problem is illustrated and discussed in greater detail below.

Various graters have been proposed in U.S. Pat. Nos. 6,520,436; 6,412,717; 6,409,107; 6,318,652; 6,315,224; 6,244,529; 6,135,375; 6,082,645; 5,803,378; 5,711,491; 5,702,061; 5,660,341; 5,562,256; 5,379,954; 5,312,054. Most of these patents describe an arrangement of grating plates, graters with exchangeable plates, or more complex mechanisms involving grating plates. U.S. Pat. No. 6,315,224 deals with the grating process itself and discloses a non-standard design for grating apertures. These patents do not, however, address the problem of formation of ribs and striations that impair grating.

### SUMMARY OF THE INVENTION

In one aspect, in a food grater, the invention provides a grating element adapted to reduce formation of ribs and striations in foodstuffs contacted with and displaced relative to the grating element. The grating element comprises a rigid base preferably formed of metal that defines a planar surface portion, and a multiplicity of projections raised from the planar surface portion. Each projection has an aperture and a cutting edge surrounding its aperture. The projections are preferably distributed such that any straight path extending along the planar surface portion and through the projections in any direction is obstructed by at least one cutting edge, avoiding formation of ribs and striations. The grater may be manually operated in which case the grating element will typically be held stationary while foodstuffs are displaced by hand, or the grater may be motor operated in which case foodstuffs will typically remain stationary while the grating element is displaced.

Other aspects of the invention will be apparent from a description below of a preferred embodiment and will be more specifically defined in the appended claims.

### BRIEF DESCRIPTION OF THE DRAWINGS

The invention will be better understood with reference to drawings illustrating a preferred embodiment, in which:

FIG. 1 is an elevational view of a prior art grater;

FIG. 2 is a perspective view of a block of hard cheese applied to the grater, showing ribs and striations that typically form during grating;

FIG. 3 is an elevational view of a cheese grater embodying the invention.

Grating projections shown in the drawings are conventional. The size of the grating projections has been exaggerated, and the shape of their openings and the shape of their cutting edges have been selected solely to facilitate illustration.

### DESCRIPTION OF PREFERRED EMBODIMENT

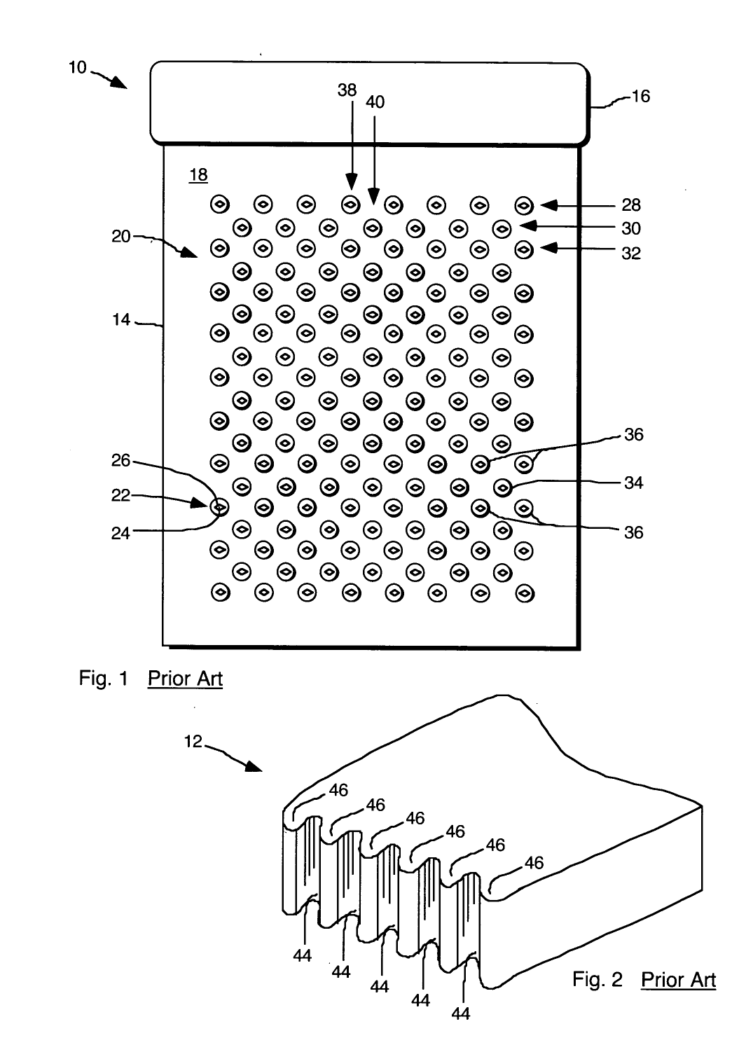

Reference is made to FIG. 1 which illustrates a prior art hand-held grater 10 which might commonly used to grate a hard parmesan cheese (such as the block of cheese 12 illustrated in FIG. 2) or other foodstuffs. The grater 10 has a base 14 stamped from thin steel sheet, and a conventional handle 16 fastened to the base 14. The base 14 has a generally planar surface or face 18 from which a multiplicity of identical domed projections (collectively indicated with reference numeral 20) are raised. A typical projection 22 is stamped with a central aperture 24 surrounding by a cutting edge 26.

It will be noted that the projections 20 cover a generally rectangular portion of the operative surface 18, and are arranged in horizontal rows (such as exemplary rows 28, 30, 32) with a common horizontal spacing between adjacent projections in any row. Alternate rows (such as row 30) are staggered horizontally relative to immediately adjacent rows (such as rows 28, 32 above and below row 30) by one-half of the common spacing between adjacent projections in each row. This arrangement causes the projections 20 to be substantially equidistant from immediately adjacent projections, the projection 34 and four immediately adjacent projections 36 being typical. The cutting edges of the projections 20 consequently align in vertical columns as indicated with lead lines 38, 40. The lead lines 38, 40 also indicate the general direction of up-and-down grating motion normally used. The adjacent columns 38,40 are spaced by one-half of the spacing between adjacent projections in the rows. Another prior art arrangement is to confine the projections 20 to a generally trapezoidal surface area, narrow adjacent the handle or top of the grater and expanding laterally to a broad base. The manner of distributing the projections remains essentially the same and suffers the same shortcoming.

FIG. 2 illustrates the effect of using such a prior art grater 10 to grate a block 12 of parmesan cheese. The surface of the block 12 that contacts the grater 10 develops a set of parallel striations 44 that alternate with a set of parallel ribs 46. These striations 44 result from the block 12 of cheese riding the peaks or cutting edges of projections 20, for example, the peaks in columns 38, 40. Eventually the ribs 46 contact lower portions of the projections 20, and tend to lodge and travel in the grooves between columns as the block 12 is moved manually with up-and-down strokes. The ribs 46 then limit engagement of the rest of the block 12 with the cutting edges of the projections 20, impairing grating action. In many instances, only sparse amounts of grated cheese can be produced with each stroke.

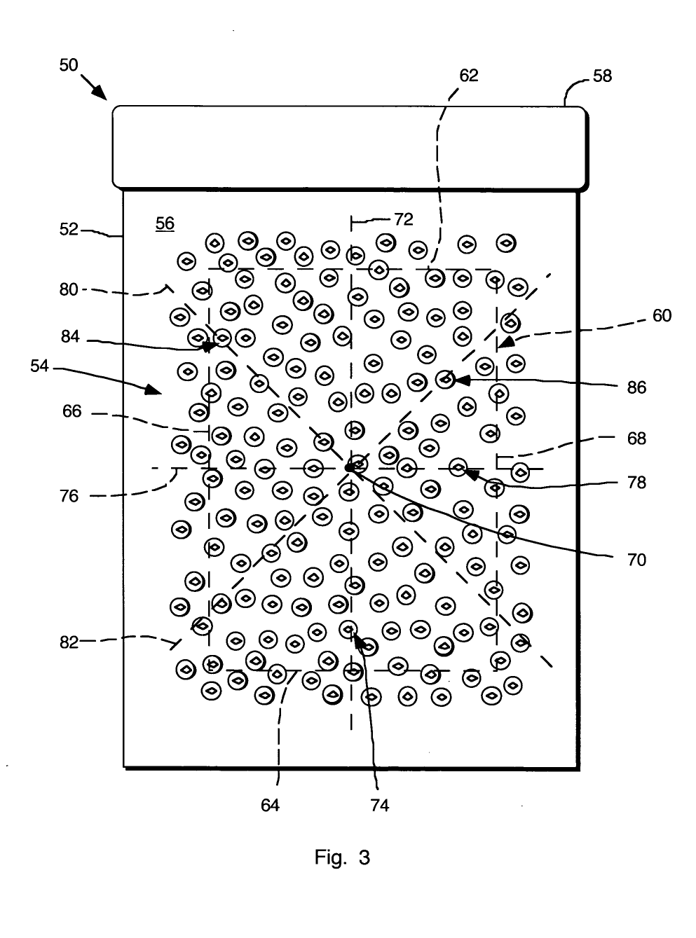

FIG. 3 illustrates a new manual grater 50 embodying the invention. The grater 50 has a grating element which consists of a generally rigid planar base 52 stamped from sheet metal. The stamping raises a multiplicity of domed grating projections (collectively indicated with reference numeral 54) from one face 56 of the base 52. The projections 54 are identical to the projections 20 characteristic of the prior art grater 10, each stamped with a central aperture and a cutting edge surrounding the aperture to provide cutting edge. The exact shape of the aperture is not critical but using a cutting edge that surrounds the aperture ensures grating action regardless of the direction from which the projection is approached. Lateral edges of the base 52 may be bent (not shown) as in the prior art to impart desired rigidity. A conventional handle 58 facilitates handling of the grater 50.

The projections 54 may be distributed so as to occupy a rectangular surface area (as shown but not numbered). Peripheral surfaces of that area may not comprise sufficient projections, especially horizontally, to guarantee the absence of ribs and striations with vertical and horizontal strokes, but this is not critical to the invention. What is significant is that a central operative surface portion where grating is performed, such as the rectangular area indicated in phantom outline and identified with the reference numeral 60, does have projections in sufficient density and properly positioned. The operative surface area 60 has an opposing pair of upper and lower sides 62, 64 and another pair of opposing lateral sides 66, 68 transverse to the first pair 62, 64. The center of the operative surface area 60 has been indicated at 70.

In FIG. 3, four exemplary grating paths are identified with phantom lines. Each of the paths extends along the operative surface area 60 and, in this instance, centrally through the projections 54. A vertical path 72 that extends between opposing upper and lower sides 62, 64 of the operative surface area 60 is obstructed by cutting edges, for example, at 74. An exemplary horizontal path 76 between lateral sides 66, 68 of the operative surface area 60 is obstructed by cutting edges, for example, at 78. Two inclined paths 80, 82 between the lateral sides 66, 68 are obstructed, respectively, at 84, 86. More generally, any straight line path extending through the center 70 of the operative operative surface area 60 in any direction is obstructed by at least one cutting edge. As well, any straight line path between the opposing upper and lower sides 62, 64 and any straight line path between the opposing lateral sides 66, 68 are similarly obstructed. The operative surface area 60 may be trapezoidal, as in the prior art, with projections distributed as described above to achieve similar grating characteristics along paths through the center of the area and between opposing sides. The exact shape of the operative surface is not critical to broader aspects of the invention.

The new grater 50 of FIG. 3 is used in the same manner as the prior art grater 10 of FIG. 1. A hard foodstuff, such as the block of parmesan cheese 12, may be manually contacted with the operative face 56 and simultaneously displaced in an up-and-down fashion or in other directions. The new grater 50 does not produce the pronounced striations 44 and ribs 46 shown in FIG. 2 and associated with prior art graters. The surface of a foodstuff exposed to the grating projections 54 remains substantially flat which ensures that grating action is not impaired. A similar benefit is obtained if the foodstuff and

It will be appreciated that a particular embodiment of the invention has been described and that modifications may be made therein without necessarily departing from the scope of the appended claims.

I claim:

1. In a food grater, a grating element adapted to reduce formation of ribs and striations in foodstuffs contacted with and displaced relative to the grating element, the grating element comprising:
a rigid base defining a planar surface portion; and,
a multiplicity of projections raised from the planar surface portion, each of the projections comprising an aperture and a cutting edge surrounding the aperture, the projections distributed on the planar surface portion such that any straight path extending along the planar surface portion and centrally through the projections in any direction is obstructed by at least one of the cutting edges.

2. The food grater of claim 1 adapted for manual grating of the foodstuffs, the grater comprising a handle attached to the rigid base.

3. A hand-operated food grater adapted to reduce formation of ribs and striations in foodstuffs during grating, comprising:
a rigid base defining a planar surface portion with a first pair of opposing sides and a second pair of opposing sides transverse to the first pair;
a multiplicity of projections raised from the planar surface portion, each of the projections comprising an aperture and a cutting edge surrounding the aperture, the projections distributed on the surface portion such that any straight path extending along the planar surface portion between the first pair of opposing sides and any straight path extending along the planar surface portion between the second pair of opposing sides is obstructed by at least one of the cutting edges; and,
a handle attached to the rigid base.

4. In a food grater, a grating element adapted to reduce formation of ribs and striations in foodstuffs contacted with and displaced relative to the grating element, the grating element comprising:
a rigid base defining a planar surface portion;
a multiplicity of projections raised from the planar surface portion, each of the projections comprising an aperture and a cutting edge surrounding the aperture, the projections distributed in a pseudorandom pattern such that a straight path extending along the planar surface portion and through the projections in any direction is obstructed by at least one of the cutting edges.

5. The food grater of claim 4 adapted for manual grating of the foodstuffs, the food grater comprising a handle attached to the rigid base.
